(19) United States
(12) Patent Application Publication
(10) Pub. No.: US 2003/0201638 A1
(43) Pub. Date: Oct. 30, 2003

(54) Compact disc storage case archive system

(76) Inventor: Jeffrey L. LeMaitre, Novato, CA (US)

Correspondence Address: JOHNSON & STAINBROOK, LLP, Suite 203, 3550 Round Barn Blvd., Santa Rosa, CA, 95403, US

(21) Appl. No.: 10/423,352

(22) Filed: Apr. 24, 2003

Related U.S. Application Data
(60) Provisional application No. 60/376,083, filed on Apr. 24, 2002.

(51) Int. Cl. B42D 1/00

(52) U.S. Cl. 281/38; 206/308.1; 206/312

(57) ABSTRACT

A compact disc storage case archive system for storing and organizing compact discs and compact disc storage cases. The system includes an archive panel having at least one pair of opposing flaps which allow for removable capture of at least one compact disc and/or compact disc storage case. In the case of storing compact disc storage cases, that while the compact disc storage case is retained by the flaps, the tray portion of the compact disc storage case is slidable in the housing portion of the storage case so as to allow removal and insertion of a compact disc in the compact disc storage case.

### CROSS REFERENCE TO RELATED APPLICATIONS

The present application claims the benefit of the filing date of U.S. Provisional/Utility Patent Application, Ser. No. 60/376,083, filed Apr. 24, 2002.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to audio and video equipment and accessories, and more particularly to a an improved filing system for organizing, segregating, and archiving compact discs and/or compact disc storage cases.

### BACKGROUND INFORMATION AND DISCUSSION OF RELATED ART

Compact discs and other portable media archive and storage systems are well known. However, many systems overlook concerns for “compactness” and opt, instead, either for ornamentation in a kind of decorative furniture or simple functionality. Such systems include compact disc and disk jewel boxes, trays, towers, and the like. The more physically compact systems include multimedia wallets or loose leaf binder sheets having sleeves (typically transparent) into which CDs or 3½ inch disks may be inserted and stored. Unfortunately, such systems are cumbersome to use, routinely require considerable effort to remove CDs from the sleeves, and do not provide full protection for the CDs. Additionally, the storage sleeves in the binder sheets are very thin and make inserting and removing compact disc difficult.

Other well known systems include the apparatus described in U.S. Pat. No. 4,971,195 to Mitsuyama, which discloses a transparent storage sleeve with a tab area and a holder for literature. Similarly, U.S. Pat. No. 5,462,160 to Young shows a transparent sleeve storage system for compact discs which uses the spine label for CD identification.

U.S. Pat. No. 5,555,977, to Oshrey et al, discloses a clear-sleeve CD indexing and storage system. U.S. Pat. No. 5,769,216 to Collins teaches a foldable paper CD holder suitable for mailing or transporting CDs.

Although there are merits, features and advantages of the devices disclosed in the above cited references, none of them achieves or fulfills the purposes of the present invention. They fail to provide for a compact disc storage system adapted for holding both CDs and compact disk storage cases, and that allow for rapid and easy insertion and removal of the media. Most importantly, to date there is no known archiving system adapted for holding the compact disc storage case apparatus taught in U.S. Pat. No. 5,715,970, known as the compact disc storage case. Accordingly, there is disclosed herein a method and apparatus for storing the compact disc storage case which fully exploits the mechanical advantages of the compact disc storage case while providing for multi-disk storage.

### BRIEF SUMMARY OF THE INVENTION

The present invention is an improved compact disc and/or compact disc storage case archive system comprising a planar panel and opposing flaps that capture and hold either compact discs or compacts disk storage cases. Also disclosed is a method of storing and archiving compact discs and compact disc storage cases.

Novel features that are characteristic of the invention, as to organization and method of operation, together with the objects and advantages thereof, will be best understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

### BRIEF DESCRIPTION OF THE SEVERAL VIEWS OF THE DRAWINGS

FIG. 1 is a perspective view of the compact disc storage case archive system of the present invention;

FIG. 2 is a side view in elevation of the improved compact disc storage case apparatus (as taught in U.S. Pat. No. 5,715,970) for which the present invention is designed as a storage apparatus;

FIG. 3 is a side view in elevation of the apparatus of compact disc storage case archive system of FIG. 1;

FIG. 4 is a side view in elevation showing the inventive apparatus as a compact disc storage case is being slipped under its first, distal flap;

FIG. 5 is a side view in elevation of the apparatus as shown in FIG. 1, taken along section lines shown in FIG. 1, and showing the compact disc storage case fully captured by both the distal and proximal flaps; and

FIG. 6 is a side view in elevation showing the inventive apparatus with one storage case captured on one side of the archive panel and another storage case partially installed.

### DRAWING REFERENCE NUMERALS

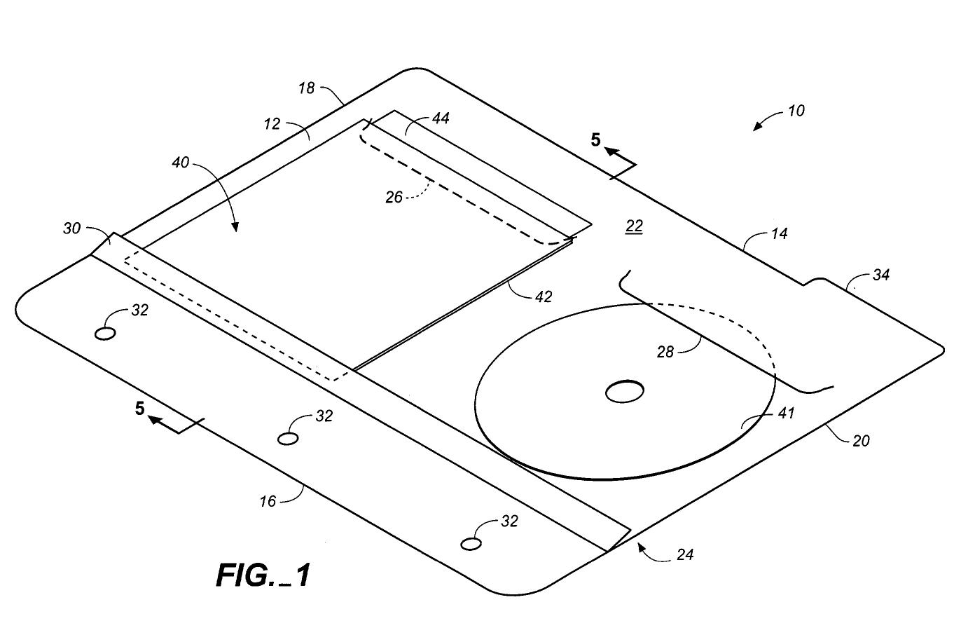

FIGS. 1-5

10 first preferred embodiment of inventive apparatus, generally

12 archive panel

14 distal edge of panel

16 proximal side of panel

18 top edge of panel

20 bottom edge of panel

22 front side of panel

24 back side of panel

26 first distal flap

28 second distal flap

30 single proximal flap

32 proximal holes

34 tab for panel identification

40 compact disc storage case 40

41 compact disc

42 housing portion of compact disc storage case

44 tray portion of compact disc storage case

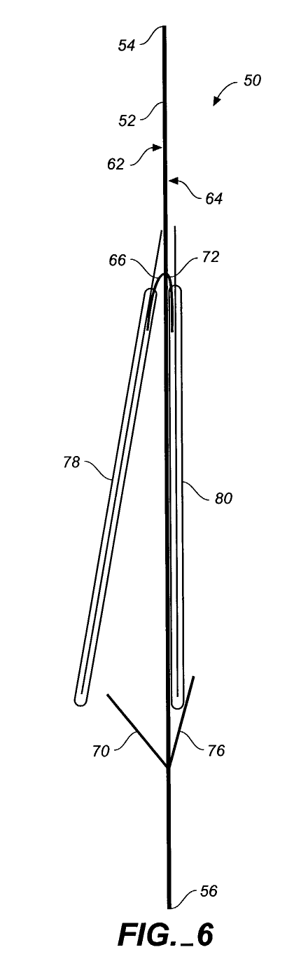

FIG. 6

50 second embodiment of inventive apparatus, generally

52 archive panel

54 distal edge of panel

56 proximal edge of panel

58 top edge of panel

60 bottom edge of panel

62 front side of panel

64 back side of panel

66, 68 first set of distal flaps

70 first proximal flap

72, 74, second set of distal flaps

76 second proximal flap

78, 80 compact disc storage cases

### DETAILED DESCRIPTION OF THE INVENTION

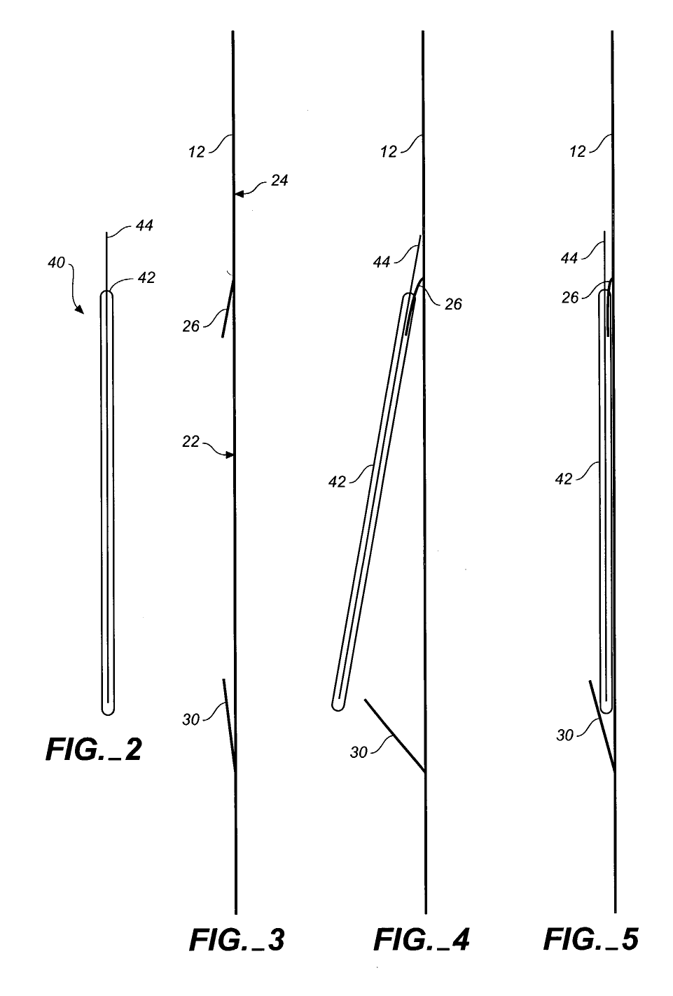

Referring to FIGS. 1 through 6, wherein like reference numerals refer to like components in the various views, there is illustrated therein a new and improved compact disc storage case archive system. FIG. 1 is a perspective view of the inventive system, and FIG. 2 is a side view in elevation of the compact disc storage case apparatus that is stored by the instant invention. The above-referenced improved compact disc storage case apparatus is disclosed in U.S. Pat. No. 5,715,970, incorporated in its entirety herein by reference. The storage case, in its most essential aspect, is depicted in FIG. 2. FIG. 3 is a side view in elevation showing the inventive apparatus without any compact disc or compact disc storage case captured. FIG. 4 is a side view in elevation showing the inventive apparatus as a compact disc storage case is being slipped under its first, distal flap, while FIG. 5 is a side view in elevation of the apparatus as shown in FIG. 1, taken along the section lines indicated in FIG. 1, and showing the compact disc storage case fully captured by both the distal and proximal flaps.

These views show that the present invention, generally denominated 10 herein, comprises a unitary and substantially planar archive panel 12 having a distal edge 14, a proximal edge 16, a top edge 18, a bottom edge 20, a front side 22, and a back side 24. The archive panel may be fabricated from any of a number of suitable materials having a degree of both flexibility and structural rigidity. A thin stiff cardboard or heavy bond paper may be suitable, as may a lightweight plastic or other thin but sturdy material. The panel includes at least two distal flaps 26, 28, a single proximal flap 30 and a plurality of proximal holes 32 which render the panel suited for placement into a ring binder (not shown). The panel optionally includes a tab 34 for identification of the panel as a distinct panel among a plurality of panels.

FIG. 1 shows that the inventive apparatus is adapted for holding both compact disc storage cases 40 and compact discs 41. FIG. 2 illustrates a compact disc storage case 40 in its most essential aspect, comprising a housing portion 42 and a tray portion 44. The case is preferably fabricated of stiff paper or cardboard. The tray portion functions as a kind of planar drawer and holds a CD; it slides into and out from the housing portion. However, when extended completely, the tray is stopped from coming completely out from the housing portion while yet presenting the CD for easy removal from the storage case. Complete and enabling details of the compact disc storage case configuration may be found in U.S. Pat. No. 5,715,970, which, as noted, is incorporated in its entirety herein.

FIGS. 4 and 5 show the method of capturing and storing the compact disc storage case using the storage system of the present invention. FIG. 4 is a side view in elevation showing the inventive apparatus with a compact disc storage case being captured. The first step in accomplishing this task is to position the compact disc storage case so that a distal flap 26 may be placed between the tray and housing portions of the compact disc storage case and into the housing portion so that the tray is disposed above the distal flap. The next step to complete the insertion is to bend the proximal flap back to accommodate the bottom edge of the compact disc storage case and then to release the flap to fully capture the compact disc storage case.

FIG. 5 is a side view in elevation of the apparatus as shown in FIG. 4, taken along the section lines shown in FIG. 1, and showing a compact disc storage case fully captured by both the distal and proximal flaps. While held securely by the flaps, the compact disc storage case tray may yet be easily slid into and out from the compact disc storage case housing, thus permitting easy access to a compact disc while providing protected storage in a multi-disk environment.

As will be readily appreciated by those with skill in the art, under some circumstances it may be desirable to provide means for storing more than two storage cases or compact discs per panel. Accordingly, as shown in FIG. 6, a second preferred embodiment 50 of the present invention comprises a planar archive panel 52 having a distal edge 54, a proximal edge 56, a top edge 58, a bottom edge 60, a front side 62, and a back side 64. The panel further includes a first set of distal flaps 66, 68 (the latter not shown), a first proximal flap 70 and a plurality of proximal holes (not shown) which enable placement in a ring binder. The second preferred embodiment further includes a second set of distal flaps 72, 74 (the latter now shown), and a second proximal flap 76, each disposed on the back side 64 of the archive panel 52. In this manner, compact disc storage cases 78, 80, may be captured on each side of the archive panel.

In another and more essential aspect, the inventive apparatus comprises a compact disc storage case archive system specifically adapted for storing and organizing compact disc storage cases, and need not include anything more than a substantially planar panel having at least one pair of opposing flaps, said flaps allowing for removable capture of a compact disc storage case, such that while the storage case is captured by said flaps, the tray portion of the storage case is slidable in the housing portion of the storage case. The panel may be of any shape or size, and the flap configuration is not limited so as to present the storage case in a particular orientation. It will be readily apparent, for example, that the opposing flaps would be configured to run from proximate the proximate edge 16 to proximate the distal edge 14, so that captured media would be disposed at 90 degrees relative to the above-described panel. In this manner, a compact disc storage case would be disposed such that the tray portion 44 would be disposed upwardly, toward the upper edge 18 of the panel. It will be equally obvious to one having skill in the art that there is no limit to the number of sets of opposing flaps that could be so located, the limitation depending only upon the overall dimensions of panel 12.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A compact disc storage case archive system for storing and organizing compact discs and compact disc storage cases, comprising:
a substantially planar panel having at least one pair of opposing flaps, said flaps allowing for removable capture of at least one compact disc or one compact disc storage case, such that if a compact disc storage case is captured by said flaps, the tray portion of the compact disc storage case is slidable in the housing portion of the compact disc storage case so as to allow removal and insertion of a compact disc in the compact disc storage case.

2. The compact disc storage case archive system of claim 1, wherein said panel has a distal edge, a proximal edge, a top end, a bottom end, a front side, and a back side, and includes at least two integral distal flaps disposed on said front side, each with an opening, and a single proximal flap disposed on said front side and having an opening opposing the openings of said distal flaps.

3. The compact disc storage case archive system of claim 2, wherein said panel further includes least two integral distal flaps disposed on said back side, each with an opening, and a single proximal flap disposed on said front side and having an opening opposing the openings of said distal flaps.

4. The compact disc storage case archive system of claim 1, further including a plurality of proximal holes enabling the panel to be installed on the rings of a ring binder.

5. The compact disc storage case archive system of claim 1, wherein said panel includes a tab for identification of the panel as a distinct panel among a plurality of panels.

6. The compact disc storage case archive system of claim 1, wherein said panel is fabricated of paper.

7. The compact disc storage case archive system of claim 1, wherein said panel is fabricated of plastic.

8. A compact disc storage case archive system for storing and organizing compact disc storage cases and compact discs, comprising:
a substantially planar panel;
at least one pair of opposing flaps disposed on said panel, said flaps allowing for removable capture of either a compact disc or a compact disc storage case having a housing and a tray portion, characterized in the tray portion of a captured compact disc storage case is slidable in the housing portion of the storage case such that a CD selectively can be completely enclosed in the housing portion or presented for removal from the housing portion.

9. The compact disc storage case archive system of claim 8, wherein said pair of opposing flaps comprises at least one first flap having an opening and at least one second flap having an opening opposing the opening of said first flap, and wherein when a compact disc storage case is captured, said first flap is placed between the tray and housing portions of the compact disc storage case and into the housing portion so that the tray is disposed above the first flap.

10. The apparatus of claim 9, wherein said panel includes a proximal edge, a distal edge, an upper edge and a lower edge.

11. The apparatus of claim 10, wherein said at least one first flap is a distal flap and said at least one second flap is a proximal flap.

12. The apparatus of claim 10, wherein said opposing flaps flap run proximate said proximate edge to proximate said distal edge.

13. A method of storing compact disc storage case, said method comprising the steps of:
(a) providing a compact disc storage case archive system having a substantially planar panel and at least one pair of opposing flaps disposed on said panel that allow for removable capture of either a compact disc or a compact disc storage case having a housing and a tray portion, characterized in the tray portion of a captured compact disc storage case is slidable in the housing portion of the storage case such that a CD selectively can be completely enclosed in the housing portion or presented for removal from the housing portion;
(b) positioning the compact disc storage case proximate the archive panel so that a one of said opposing flaps may be placed between the tray and housing portions of the compact disc storage case and into the housing portion so that the tray is disposed above the flap;
(c) bending the other opposing flap back to accommodate the bottom edge of the compact disc storage case; and
(d) releasing the flap to fully capture the compact disc storage case.
